(19) United States
(12) Patent Application Publication
(10) Pub. No.: US 2011/0220160 A1
(43) Pub. Date: Sep. 15, 2011

(54) CLEANING ARRANGEMENT

(75) Inventor: Epke Bosma, Holo (SE)

(73) Assignee: DELAVAL HOLDING AB, Tumba (SE)

(21) Appl. No.: 13/130,366

(22) PCT Filed: Dec. 8, 2009
(86) PCT No.: PCT/EP09/66582

§ 371 Date: May 20, 2011

(30) Foreign Application Priority Data
Dec. 18, 2008 (SE) 0850151-2

(51) Int. Cl. B08B 3/00

(52) U.S. Cl. 134/56 R

(57) ABSTRACT

An arrangement for controlling the supply of cleaning liquid into a milking system includes a pressurizing arrangement adapted to pressurize the cleaning liquid, a supply arrangement for selectively supplying cleaning liquid and a pressure sensing arrangement for sensing the pressure in the milking system. The pressure sensing device is operatively connected to the supply arrangement, and the supply arrangement is adapted to supply cleaning liquid into the milking system depending on the sensed pressure in the milking system. The arrangement can be adapted to supply cleaning liquid when the sensed pressure in the milking system is below the atmospheric pressure.

### TECHNICAL FIELD

The invention relates to a milking system including means for supplying a cleaning liquid into the milking system. Especially, it relates to an arrangement for supplying cleaning liquid into a milking unit of the milking system.

### BACKGROUND TO THE INVENTION

The invention relates to milking systems and cleaning of milking systems. Milking systems comprise equipment for milking animals, such as cows, commonly including milking units that are attached to the animals, a vacuum source and a container, wherein the vacuum is arranged to draw the milk from the animal through the milking unit to the container. These milking systems needs to be cleaned so that milk remains are removed from its internal surfaces, which come into contact with the milk, e.g. inner walls of hoses, pipes, valves and containers. A common way to clean milking systems includes positioning and connecting teat cups of the milking units on water supply nozzles, and draw the water into the milking units, by means of the vacuum source, and further to the container. In this way the water passes the same interior surfaces during cleaning as the milk does during milking.

When installing milking systems a proper supply of water is therefore important. Several problems might arise that complicate the installation. One example is that if the water supply is far away from the milking station it can be difficult for the milking system to draw the water all the way from the supply. Other examples are that it might not be desirable to extend a water line across the installation which hinders cleaning of the installation or hinders transport of equipment. To place the water line out of the way the water line can include elevated segments so that vehicles, animals and personnel can pass under. However, elevating a segment of the line increases the pressure of the water, for example when pumping the water up to the height of the elevated portion. The raised pressure increases the risk of leakage. Moreover, the milking equipment into which the water is drawn is designed for a vacuum suction and if the water that enters into the system is pressurised it will leak out for example through air inlets in the milking units, and possibly damage the milking units.

### SUMMARY OF THE INVENTION

It is an object of the invention to overcome the disadvantages of the prior art and provide an arrangement that handles a pressurised cleaning liquid, for example, water being pumped over a long distance to the milking system. It is also an object of the invention to prevent leakage of the pressurised cleaning liquid that is supplied to a milking system.

A further object of the invention is to protect milking units from overpressure in the cleaning liquid supplied into the milking units, an overpressure that might be caused by, for example, the cleaning liquid being pressurised by a pump to be transferred a longer distance from the liquid source and/or if the cleaning liquid is subjected to large height variations along the way from the liquid source. Besides being caused by pumping the liquid, such pressure increase may also be created if the liquid is drawn up to a higher level by a vacuum, from which level the liquid subsequently flows down is towards a milking unit. Especially when installing cleaning equipment in large milking systems, or expanding milking systems, it may also arise a need to ensure a proper supply of cleaning liquid to all parts of the system, for example by pumping cleaning liquid in the system. To make sure the liquid reaches all milking units the pressure has to be high. When providing such a supply of pressurised cleaning liquid it is important to balance the system and not to subject individual milking units to a liquid pressure level that may harm the equipment.

For these purposes, the invention provides an arrangement for controlling the supply of cleaning liquid into a milking system comprising a pressurising arrangement adapted to pressurise the cleaning liquid, a supply arrangement for selectively supplying cleaning liquid and a pressure sensing device arranged for sensing the pressure at the milking system, wherein the pressure sensing device is operatively connected to the supply arrangement and the supply arrangement is adapted to supply cleaning liquid into the milking system depending on the sensed pressure in the milking system.

Preferably, the arrangement is adapted to supply cleaning liquid if the sensed pressure in the milking system is below a threshold level, e.g. if the pressure is lower than the atmospheric pressure.

In this way the arrangement is adapted to supply cleaning liquid as a response to a sensed vacuum pressure.

By sensing a vacuum at the milking system before supplying liquid the risk for leaking cleaning liquid is reduced. Also, the risk for damaging the milking equipment is also reduced.

An embodiment includes a pump for pressurising the cleaning liquid so that it can be properly supplied to all parts of the milking system.

An embodiment comprises a portion of a supply line for the cleaning liquid which portion is elevated in relation to the milking system. Such a portion can position the supply line in a proper place and pressurises the cleaning liquid. The liquid can be pumped through the elevated portion or be drawn through the elevated portion by the milking system vacuum. Moreover, air injectors can be arranged in the supply line, to inject air behind the liquid, if a suction provided by the milking system should be used to transport the liquid upwards and through an elevated portion of the supply line.

Preferred embodiments of the invention also limits the pressure in the cleaning liquid supplied to the milking unit so that an overpressure in the supply line is throttled to a lower pressure before the cleaning liquid reaches the milking units. For this purpose the supply arrangement comprises a throttling valve arranged to reduce the pressure of the pressurised cleaning liquid, preferably reduce the pressure to a pressure below the atmospheric pressure. In this way it is also easier to provide a supply of cleaning liquid to a plurality of milking stations located at different heights, since pressure differences due to the height variations can be levelled out by throttling valves arranged in cleaning liquid conduits lines at each respective milking station. The pressure provided by a common cleaning liquid distribution pump can be dimensioned so that a proper supply reaches the milking station farthest away without subjecting the milking stations that are arranged closer to damaging high pressure levels.

The throttling valve, or each of the throttling valves, can be an electronically controlled valve that is controlled on the basis of the sensed pressure at the connection to the milking unit. It can alternatively be a mechanical construction that passively adjusts the throttling in dependence of the downstream pressure of the valve at the milking unit.

In an embodiment the pressure sensing arrangement includes a pressure sensor for example arranged in a teat cup of the milking system.

In an embodiment the pressure sensing arrangement includes a membrane, for example arranged in a supply line for the cleaning liquid.

In an embodiment the pressure sensing arrangement is provided in a nozzle of the supply line, wherein the nozzle is adapted for connection to a milking unit of the milking system.

In an embodiment the supply arrangement includes a supply valve to effectuate the supply.

### BRIEF DESCRIPTION OF THE DRAWINGS

The invention will be further described below with reference to the figures. The figures illustrate parts of the arrangements to describe the invention's main features that can be used for improving milking systems of the prior art. The drawings are only illustrative and simplified pictures of milking systems and cleaning equipment and they are not drawn to scale.

FIG. 1 illustrates an arrangement for supplying cleaning liquid to milking stations, such as milking robots.

FIG. 2 illustrates an arrangement wherein cleaning liquid is supplied to milking stations arranged as in a parlor.

FIG. 3 illustrates a valve that can be arranged to reduce the pressure of the cleaning liquid.

FIG. 4 illustrates an alternative arrangement of the supply to the milking station of FIG. 1.

FIG. 5 illustrates an alternative positioning of supply valves, wherein one supply valve is placed at each teat cup of the milking unit, the supply valves being arranged also as part of the respective connection nozzles for the teat cups.

### DETAILED DESCRIPTION OF EMBODIMENTS

The figures describe arrangements for controlling the supply of cleaning liquid, which cleaning liquid is pressurised during the transfer of the liquid from a source to a milking station of the milking system. An example of a suitable and common cleaning liquid is water, which can be heated, mixed with a detergent or mixed with steam and be used in different mixtures and temperatures sequentially during a cleaning session. In the illustrations, the liquid is pressurised by a pump and this is beneficial for distributing liquid in larger installations and overcoming height obstructions for the supply line. However, the liquid can be pressurised by other means for example by being supplied from a container arranged at a higher level than a milking unit. Also, the liquid can be drawn by the vacuum in a milking unit through a supply line that have elevated portions, for example above walkways, so as not to obstruct personnel or equipment. Such elevated portions pressurises the liquid in lower positioned downstream portions of the supply line. Elevated portions increase the pressure of the liquid, since the height of a liquid creates its hydrostatic pressure. To reach the elevated portion, the liquid can be pressurised and pumped by a liquid pump. Alternatively the liquid can be drawn by a suction provided by means of a vacuum pump, i.e. a vacuum is provided in front of the liquid and the atmospheric pressure is provided behind the liquid. A further alternative is to use the pressure as provided in the water line from a water supply plant and feed the water into a container at a height above the milking equipment, the water can then flow down to the milking station, passing line portions above (and also below) the milking equipment on its way down. The system can be also be configured to employ a combination of two (or all three) of these means for overcoming elevations, especially feeding the cleaning liquid by means of a pressurising pump to a milking unit being put under vacuum by a vacuum pump.

The supply of liquid is initiated when milking units have been connected to the supply line and a vacuum is applied to the milking units. The supply is suitably also throttled so that the cleaning liquid enters the milking units at a sub-atmospheric pressure.

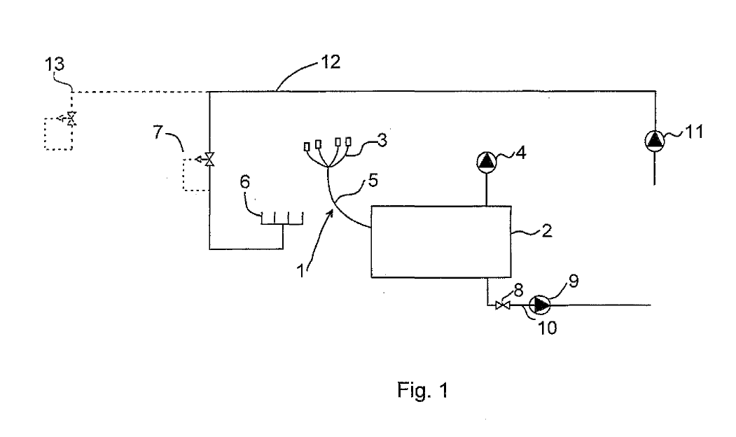

FIG. 1 illustrates a milking station and a supply line 12 for cleaning liquid for supplying cleaning liquid to the milking station. The illustrated milking station is an automatic milking robot. For clarity and ease of understanding, only the main milk conveying portions of the robot is illustrated, whereas other equipment, such as electronic control units for controlling for example means for identifying and milking the animal and means for example for testing the extracted milk have been omitted. The milking station comprises a milking unit 1, including teat cups 3, for attachment to the animal to be milked, a claw and hose 5, and a milk receiver 2 that is connected to a vacuum pump 4 for putting the receiver 2 under vacuum during milking and provide a milk extracting vacuum to the claw 5 and teat cups 3. The milking robot is adapted to extract milk from an animal into the milk receiver 2. The milking robot also includes an outlet connected, via an outlet valve 8, to a milk transferring line 10 and a milk pump 9 is arranged at the outlet, in the milk line 10, for transferring the extracted milk from the milk robot to a storage tank (not shown) after extraction.

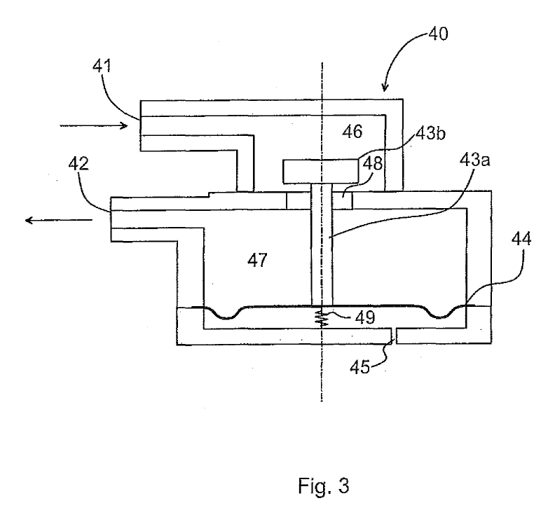

The supply arrangement comprises a supply line 12, which is arranged for leading pressurised cleaning liquid from a supply of cleaning liquid, such as a cleaning unit, to the milking robot. A liquid pump 11 is arranged for pressurising and pumping the cleaning liquid via the supply line 12 to the milking station. The supply line 12 leads to nozzles 6, which nozzles end the supply arrangement and are adapted for connection to the milking station, so that cleaning liquid can be supplied into the milking station. The illustrated embodiment shows a plurality of nozzles 6, adapted for attachment to the teat cups 3 of the milking unit 3. Four teat cups are illustrated, suitable for milking an animal with four teats, such as a cow. During cleaning the teat cups 3 are connected to the nozzles 6 for receiving the cleaning liquid that is supplied to the milking station through the teat cups. A supply valve 7 is arranged in the supply line, for selectively opening and closing the supply of cleaning liquid to the milking station. The supply valve 7 preferably includes a throttling mechanism for reducing the pressure of the supplied cleaning liquid before it reaches the milking equipment. The arrangement is adapted to only open the supply valve when there is a suction vacuum downstream the valve so that when the teat cups are disconnected from the nozzles of the supply line, the supply valve is closed. This operation of the supply valve can be provided by using an electronic supply valve that is controlled by a control unit connected to a pressure sensor at the downstream milking system side of the supply valve. The control unit can be provided for by a locally arranged control unit including for example a microprocessor or a centrally arranged control unit, such as a computer, connected to and controlling a plurality of supply valves, leading to several milking stations. The valve can also be wholly mechanical, an example of which is described in FIG. 3. The pressure sensing is indicated by a dotted line between the valve 7 and the supply line 12 at a position downstream the valve 7, indicating that the pressure sensing arrangement senses the pressure downstream the supply valve.

Moreover, if the teat cups are connected to the nozzles but the vacuum supplied to the teat cups is interrupted, the supply valve is closed. Thus, a failing vacuum source or supply or a failing connection between a nozzle and a teat cup will close the supply valve so that liquid is prevented from exiting the nozzles when there is no suction. Thus, it can be assured that there is vacuum present, which takes care of the supplied liquid and prevents leakage.

The arrangement can be used for supplying cleaning liquid to a plurality of milking stations. The supply line 12, leading pressurised cleaning liquid from the liquid pump 11, can be branched into a plurality of supply lines, one for each milking station. The additional supply line (indicated by a broken line 13), or supply lines, can suitably be provided with a pressure reducing supply valve (similar to 7 in line 12), In this way the same liquid pump 11 can be used to pressurise the cleaning liquid for a plurality of milking stations, the pressure delivered by the pump 11 being controlled to be large enough so that cleaning liquid will reach all milking stations, and wherein the pressure in each supply line 12, 13 is reduced by means of a respective pressure reducing valve 7 in each supply line 12, 13 to a low pressure before the nozzles 6 of each milking station. The low pressure is suitably a pressure below the atmospheric pressure, as provided in the milking units 3 by the vacuum pump 4.

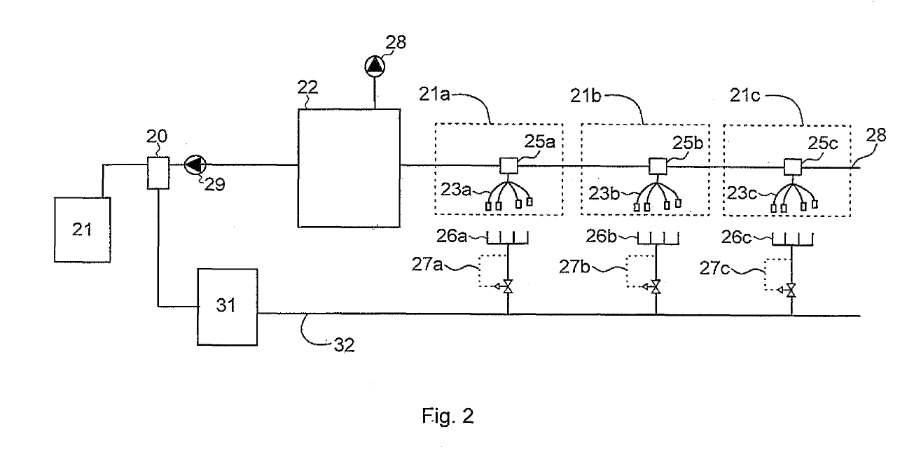

FIG. 2 illustrates a plurality of milking stations 21a-c arranged side by side, such as in a milking stall, and a supply line 32 for cleaning liquid, which supply line is branched into individual supply lines, one for each milking station. This milking system includes a plurality of milking units 21a-c connected to the same milk receiving container 22, to which the milk, during milking, is drawn by means of vacuum, as provided by a vacuum pump 28 arranged at the milk receiving container 22. The system includes means for transferring the extracted milk from the milk receiving container 22 to a milk tank 21, including a milk line provided with a milk pump 29 and a valve 20. The arrangement also includes a supply arrangement for supplying cleaning liquid to the milking units, leading from a pressurising arrangement exemplified by cleaning unit 31, and including a cleaning liquid supply line 32 leading to the milking units. The supply line 32 branches into one individual supply line for each milking unit, further branching into feeding nozzles 26a-c in each individual supply line. A supply valve 27a-c is arranged in each individual feeding line for selectively supply the cleaning liquid to the milking units. The supply valve 27a-c includes a throttling mechanism that reduces the pressure of the cleaning liquid being supplied to each milking unit 21a-c. A selective valve 20 adapted to selectively connect the milk pump 29 to the milk tank 21 and the cleaning unit 31 is arranged in the milk line. During cleaning, the valve can suitably be connected to the cleaning unit so that the cleaning liquid returns to the cleaning unit, which pressurises the cleaning liquid and re-circulates it. Each pressure reducing supply valve 27a-c reduces the pressure of the supplied cleaning liquid to a low pressure suitable for supply into the milking units. To control the pressure of the cleaning liquid on the downstream low pressure side a pressure sensing arrangement is provided. A control unit that uses an electronic pressure sensor to determine the downstream pressure of the supply valve, and uses the result for controlling the throttling of the supply valve 27a-c, can provide the pressure sensing arrangement. An alternative is to use a mechanical pressure reducing supply valve 27a-c as described in FIG. 3. This mechanical valve includes a pressure sensing membrane that is operatively connected to a throttling mechanism of the valve. These supply valves reduce the pressure independent of the pressure of the liquid upstream of the valve, and independent of the other valves, only dependent of the downstream pressure. Thus, each valve provides a throttling regulated by its downstream pressure.

FIG. 3 illustrates an embodiment of a throttling valve 40 suitable for the arrangements of the invention. The valve 40 can be arranged as the pressure reducing supply valves 7, 27, 57 of FIGS. 1, 2 and 5, respectively. The valve comprises a body (shown in a cross section) having an inlet 41 and an outlet 42 for liquid flowing through the valve 40. The valve body provides a housing for a movable closing member 43 provided in an opening 48, inside the valve, for throttling a flow of liquid between the inlet 41 and the outlet 42. The inlet 41 leads into a first chamber 46, which thus during use is filled with liquid of a first upstream pressure. A second chamber 74 is located downstream the first chamber 46 and leads to the outlet 42. 1s The first chamber 46 is fluidly connectable to the second chamber by means of the opening 48, said connection being controlled by operating the closing member 43, which is movable between a fully open and a completely closed position in the opening 48. The combination of the closing member 43 and the opening 48 acts to throttle a liquid flowing from the first chamber 46 to the second chamber 47, so that the liquid leaving the second chamber 47 though the outlet 42 will have a downstream pressure lower than the inlet pressure upstream the valve 40. The closing member 43 is exemplified as a mushroom shaped body having a stem or rod portion 43a provided with a flow restricting head portion 43b. The rod portion 43a has a small diameter, small compared with chamber 47 and the opening 48, and does not affect the flow through the valve, whereas the head portion is large, of the same size as the opening, so that it in cooperation with the opening provides a throttling of the liquid flow through the valve. Varying the distance between the head portion 43b and the opening 48 varies this throttling. The valve also includes a pressure sensing mechanism for its operation and control of the throttling. For this purpose the valve 40 is provided with a flexible membrane 44, which is subjected to the downstream pressure in the second chamber 47 on one side and is subjected to the surrounding atmospheric pressure on its other side by means of an aperture 45 in the valve body.

The difference between the surrounding atmospheric pressure 45 and the pressure in the second chamber downstream the closing member 43 acts on the closing member in the opening direction of the valve i.e. moves the head portion 43b of closing member in a direction from the opening 48, so that the larger the atmospheric pressure is compared to the downstream pressure the more open and less throttling the valve 40 is. If, on the other hand the downstream pressure is larger than the atmospheric pressure, the valve remains closed. Also, before the teat cups of the milking unit is connected and the milking system is put under vacuum, the downstream pressure is the atmospheric pressure, i.e. the pressure sensing membrane is subjected to the atmospheric pressure on both sides, and the valve remains closed until the vacuum is activated in the milking unit and the membrane opens the valve and thereby initiates the supply of liquid. Thus, liquid will only flow through the valve if there is a suction pressure downstream the valve at the nozzles (6, 26 in FIGS. 1 and 2) so that liquid having a high pressure (larger than atmospheric) will not be let through to the nozzles, thus the valve protects a milking unit connected to the nozzles from pressurised liquid.

The valve 40 has an outlet 42 being directed in the opposite direction to its inlet 41. An alternative configuration is to have the outlet directed in the same direction as the inlet, for example between two parts of a pipe running in the same direction.

An functionally equivalent valve to the mechanical valve 40 can be provided for by an electronic valve activated by an output from an electronic pressure sensor, either directly or by an electronic control unit, e.g. a computer, providing control signals that adjust the electronic valve based on the downstream pressure sensed by the electronic sensor.

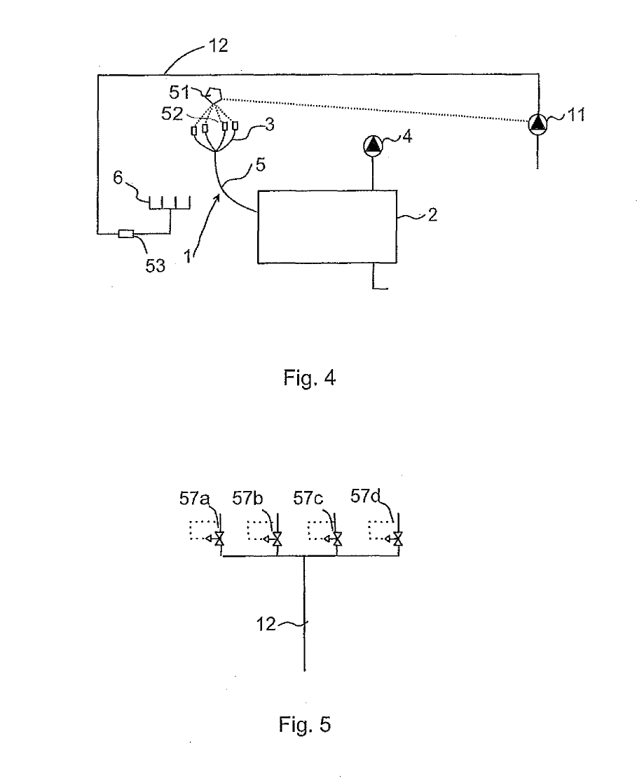

FIG. 4 illustrates a milking station, as in FIG. 1, being supplied with cleaning liquid by an alternative supply arrangement. This arrangement includes a pump 11 for pressurising the cleaning liquid that is supplied through the supply line 12. The arrangement also comprises pressure sensors 52 arranged in each individual supply nozzle 6 of the supply line. The supply of cleaning liquid is controlled by the activation or start of the pump 11, and selective inactivation of the pump. For this purpose a control unit 51 is adapted to provide control signals to the pump. The control unit is also connected to the pressure sensors 52 and uses the pressure sensed in the nozzles for controlling the pump 11. Thus, the pressure sensors are operatively connected to the supply arrangement by the control unit that provides a control signal that activates the pump as a response to a sensed vacuum. This arrangement can also include throttling means 53 in the supply line to reduce the cleaning liquid pressure. The throttling means 53 can include disc shaped flow limiting pipe inserts provided with a hole, the size of which is chosen based on the throttling needed. This is especially useful in arrangements comprising a plurality of milking stations, where the milking stations closest to a common pump 11 can be provided with the most flow limiting inserts in their respective supply lines, whereas the milking stations farther away from the common pump 11 can be provided with discs with little or no throttling effect.

FIG. 5 illustrates an embodiment wherein each nozzle of the branches of a supply line 12 has been provided with a respective supply valve 57a-b. The pressure sensing is also performed in the nozzles. A respective teat cup of the milking unit is connected to each nozzle having a supply valve, when the milking system is to be cleaned. The supply valves 57a-d can suitably be of the pressure reducing type illustrated in FIG. 3. In this embodiment each nozzle is provided with a pressure sensing membrane, which opens the supply valve when a vacuum is applied to the corresponding teat cup.

Alternatively, electronic valves and electronic sensors can be arranged in the nozzles, as in FIG. 5, either stand alone units or centrally controlled, e.g. as described in FIG. 4.

1. An arrangement for controlling the supply of cleaning liquid into a milking system comprising:
a supply arrangement (6, 7, 12, 13, 26, 40, 51, 53, 57) for selectively supplying cleaning liquid;
a pressurizing arrangement (11, 31) adapted to pressurize the cleaning liquid within the supply arrangement; and
a pressure sensing arrangement (27, 52) for sensing the pressure in the milking system,
wherein the pressure sensing arrangement is operatively connected to the supply arrangement, and the supply arrangement is adapted to supply the cleaning liquid into the milking system depending on the sensed pressure in the milking system.

2. The arrangement according to claim 1, wherein the pressure sensing arrangement is adapted to supply the cleaning liquid when the sensed pressure in the milking system is below a threshold level.

3. The arrangement according to claim 2, wherein the threshold level is lower than atmospheric pressure.

4. The arrangement according to claim 1, wherein the pressurizing arrangement comprises a pump (11) for pressurizing the cleaning liquid within the supply arrangement.

5. The arrangement according to claim 4, wherein the supply arrangement comprises a control unit (51) for controlling the pump, said control unit being adapted to activate the pump to supply the cleaning liquid.

6. The arrangement according to claim 1, wherein the pressurizing arrangement comprises a portion of a supply line for the cleaning liquid, which portion is elevated in relation to the milking system.

7. The arrangement according to claim 1, wherein the supply arrangement comprises a throttling valve (43, 53) arranged to reduce the pressure of the pressurized cleaning liquid being supplied to the milking system.

8. The arrangement according to claim 7, wherein the throttling valve (43, 53) is arranged to reduce the pressure to below atmospheric pressure.

9. The arrangement according to claim 1, wherein the pressure sensing arrangement includes a pressure sensor (27, 52).

10. The arrangement according to claim 9, wherein the pressure sensor (52) is arranged in a teat cup of the milking system.

11. The arrangement according to claim 1, wherein the pressure sensing arrangement includes a movably supported membrane (44).

12. The arrangement according to claim 11, wherein the membrane (44) is arranged in a supply line for the cleaning liquid.

13. The arrangement according to claim 1, wherein the pressure sensing arrangement is provided in a nozzle (6) of the supply line (12), the nozzle being adapted for connection to a milking unit (3) of the milking system.

14. The arrangement according to claim 1, wherein the supply arrangement includes a supply valve (7, 40, 57) to effectuate the supply of the cleaning liquid from the supply arrangement to the milking system.

15. An arrangement for controlling the supply of cleaning liquid into a milking unit of a milking system, comprising:
a supply arrangement comprising a supply line (12) for supplying cleaning liquid to the animal milking unit;
nozzles (6) connected to the supply line to receive the cleaning liquid from the supply line,
the nozzles connectable to teat cups of the milking unit so that, during cleaning, the cleaning liquid is supplied to the milking unit through the teat cups;
a pressure-reducing supply valve (7, 27a-c), located in the supply line upstream of the nozzles, for reducing the pressure of the cleaning liquid supplied from the supply line to the milking unit;
a pressurizing arrangement (11, 31) adapted to pressurize the cleaning liquid within the supply arrangement upsteam of the supply valve; and
a pressure sensing arrangement (27, 52) located downstream the supply valve for sensing pressure in the milking unit,
the pressure sensing arrangement operatively connected to the supply arrangement and adapted to supply the pressurized cleaning liquid, at a controlled reduced pressure, into the milking unit depending on the sensed pressure in the milking unit.

16. The arrangement of claim 15, wherein the pressure sensing arrangement comprises a sensor located intermediate the supply valve and the nozzles.

17. The arrangement of claim 15, wherein the pressure sensing arrangement comprises sensors located within each of the nozzles.

18. The arrangement of claim 15, wherein the pressure sensing arrangement is adapted to open the supply valve only when a suction vacuum is detected, by the pressure sensing arrangement, in the milking unit.

19. The arrangement of claim 18, wherein the pressure sensing arrangement is further adapted to open the supply valve to reduce the pressure of the cleaning liquid, being supplied to the milking unit, to a pressure below atmospheric pressure.
